(19) United States
(12) Patent Application Publication
(10) Pub. No.: US 2017/0249405 A1
(43) Pub. Date: Aug. 31, 2017

(54) METHOD OF INTERGROWING AND COEXISTING FOUR-IN-ONE MINERAL COORDINATED PROSPECTING

(71) Applicant: SHANDONG UNIVERSITY OF SCIENCE AND TECHNOLOGY, Qingdao (CN)

(72) Inventors: Zengxue LI, Qingdao (CN); Dawei LV, Qingdao (CN); Huaihong WANG, Qingdao (CN); Dongdong WANG, Qingdao (CN); Haiyan LIU, Qingdao (CN); Pingli WANG, Qingdao (CN); Ying LI, Qingdao (CN)

(73) Assignee: SHANDONG UNIVERSITY OF SCIENCE AND TECHNOLOGY, Qingdao (CN)

(21) Appl. No.: 15/443,395

(22) Filed: Feb. 27, 2017

(30) Foreign Application Priority Data
Feb. 29, 2016 (CN) 201610111569.4

(51) Int. Cl. G06F 17/50

(52) U.S. Cl. CPC G06F 17/5009

(57) ABSTRACT

A method of intergrowing and coexisting four-in-one multi-mineral coordinated prospecting includes the following steps: firstly, implement the coordinated prospecting to identify the occurrence states, occurrence regularities and developing conditions of multiple minerals so as to realize the coordinated prospecting and evaluation for these minerals and achieve high-precision high-benefit optimal prospecting effectiveness; secondly, implement different prospecting methods and technologies in a coordinated way and implement the exploratory drilling, geophysical prospecting, information technology and other technologies in a systematic and coordinated fashion so that the implementation of prospecting works achieves the optimal configuration, realize maximum benefit, obtain sustainable optimal prospecting effectiveness with minimum input and enhance the technological level and prospecting effectiveness of multi-mineral integrated coordinated prospecting as a whole.

### TECHNICAL FIELD

The present invention relates to a method of intergrowing and coexisting four-in-one mineral coordinated prospecting.

### BACKGROUND

“Coordinated prospecting” is a method of multi-mineral scientific prospecting that is developed on the basis of integrated prospecting and mainly includes the formation of the basic ideas for multi-mineral coexistence and gathering coordinated prospecting, the theories for multi-mineral coordinated prospecting, the establishment of coordinated prospecting models, etc. The theory system for the coordinated prospecting is the basis and support for establishing the coordinated prospecting models, so the coordinated prospecting attaches importance to the study on the prospecting theories. The four in one refers to the coexistence of minerals of four states in a specific geological system, namely, solid mineral, liquid mineral, gas mineral, and element mineral. The concepts and systems of coordinated prospecting that were presented in the past are mainly based on coal measure intergrowing minerals and the concept “coal-based and multi-mineral considered” is obviously very limited as it fully treats the “coal” as the main mineral and treats other minerals as affiliates, and doesn't indicate that the occurrence states of other minerals will lead to the differences in the prospecting technologies.

### SUMMARY OF THE DISCLOSURE

The present disclosure is aimed at providing a method of intergrowing and coexisting four-in-one mineral coordinated prospecting.

A technical solution used in the present disclosure is: A method of intergrowing and coexisting four-in-one mineral coordinated prospecting, wherein it comprises the following steps:

a. Acquire a variety of geological information and sort the key data for four-in-one multi-mineral coordinated prospecting;

b. Conduct quantitative analysis for mineral types and their spatial distribution features and determine the main mineral types and prospecting ideas, the type of used technology and basic measures for coordination;

c. Determine the geological foundation for four-in-one multi-mineral co-existence and the theories for four-in-one multi-mineral coordinated prospecting;

d. Select advanced suitable prospecting methods and technologies and establish the solid-based, liquid-based, gas-based and four-in-one mineral coordinated prospecting models on the principle of optimal benefit and sustainability; and

e. Select corresponding four-in-one multi-mineral coordinated prospecting models for four-in-one mineral coordinated prospecting.

Wherein the goal to be achieved by the said four-in-one multi-mineral coordinated prospecting is to obtain optimal geological prospecting effectiveness with minimum input and the shortest construction period, thus realizing maximum benefit.

Wherein the geological foundation for four-in-one multi-mineral coexistence in Step c specifically comprises:

c11 Basic combination types of four-in-one multi-mineral coexistence and gathering: the forms of multi-mineral coexistence and gathering include four-mineral coexistence, three-mineral gathering and two-mineral assembly;

c12 Mineralization mechanisms for four-in-one multi-mineral coexistence: Analyze the mineralization mechanisms for solid, liquid, gas and element multiple minerals and identify the main mineral controlling mechanism so as to provide guidance for prospecting practice;

c13 Four-in-one multi-mineral tectonic division and accumulation unit division: Determine the multi-mineral accumulation unit boundary, identify the controlling mechanism of mineral developing tectonics within each unit and define enrichment blocks;

c14 Temporal and spatial distribution, enrichment and evolvement regularities of four-in-one multiple minerals: Analyze the regularities of development and distribution, occurrence and enrichment of multiple minerals and their evolution in space from the view of time and space, thus providing theoretical guidance for multi-mineral coordinated prospecting.

Wherein the theories for four-in-one multi-mineral coordinated prospecting in Step c specifically comprises:

c21. Coordination of four-in-one prospecting: The coordinated prospecting is aimed at obtaining optimal prospecting results and achieving maximum economic benefits with minimum cost input, which requires systematic investigation into geological and geophysical conditions of the prospected blocks, selection of the most suitable prospecting technical means, prospecting construction organization forms and prospecting construction sequence and active implementation of the integrated coordinated trilateral work so as to maximize the benefits of prospecting works;

c22 Optimal benefits of four-in-one prospecting: Make careful economic benefit assessment for the selection of each prospecting technology, equipment input, program deployment and method adoption so as to select the coordinated prospecting program with optimal benefit;

c23 Optimization of prospecting methods and technologies: Evaluate the adaptability of various prospecting technologies and methods in specific prospected blocks on the basis of co-ordination of various prospecting technical means and methods and conduct optimization management so that all prospecting means, technologies and methods complement each other with advantages and the relationship in the implementation process of prospecting works is coordinated;

c24 Optimal environmental protection and sustainability of four-in-one coordinated prospecting: The coordinated prospecting program must include the evaluation report and technical parameters that are conducive to environmental protection and ensure the sustainability of resources prospecting, development and utilization.

Wherein the said prospecting technologies in Step d specifically comprises:

d11 one-boring-for-multiple-purposes implementation technologies;

d12 seismic sediment multi-section technologies;

d13 multi-state well logging interpretation technologies;

d14 experimental testing technologies; and

d15 four-in-one information technologies.

Wherein the said solid-based, liquid-based, gas-based and four-in-one mineral coordinated prospecting models in Step d specifically are:

d21 Solid-based mineral coordinated prospecting model: The solid-based mineral prospecting is mainly aimed at identifying the developing environment, distribution and enrichment, tectonic control and occurrence regularities of solid minerals, thus establishing corresponding metallogenic models and prospecting models;

d22 Liquid-based mineral coordinated prospecting model: The liquid-based mineral prospecting is mainly aimed at identifying the hydrocarbon generation potential of source rocks, reservoir performance, sealing conditions, migration pathway, accumulation conditions and preservation conditions, thus establishing corresponding metallogenic model and prospecting model;

d23 Gas-based mineral coordinated prospecting model: Like the liquid-based mineral prospecting, the gas-based mineral prospecting is mainly aimed at identifying the hydrocarbon generation potential of source rocks, reservoir performance, sealing conditions, migration pathway, accumulation conditions and preservation conditions, thus establishing corresponding metallogenic model and prospecting model; and

d24 Four-in-one mineral coordinated prospecting model: The mineralization and enrichment features and prospecting features of various minerals are studied comprehensively in conjunction with the prospecting features of different-state minerals so that the integrated metallogenic model and prospecting model are established.

The beneficial technical effect of the present disclosure is:

The present disclosure realizes the coordinated deployment for the implementation of multi-mineral prospecting and technologies in a coal measure or a mineral accumulation area so that the prospecting works realize more scientific, more efficient economic benefits and a higher-level prospecting effectiveness of technology coordinated implementation.

### BRIEF DESCRIPTION OF DRAWINGS

The present disclosure is further described below in conjunction with the drawings and specific embodiments:

FIG. 1 illustrates the flow block diagram for the four-in-one multi-mineral coordinated prospecting method in an embodiment of the present invention; and

FIG. 2 illustrates the framework diagram for the theories and models for the four-in-one multi-mineral coordination prospecting in an embodiment of the present invention.

### DETAILED DESCRIPTION OF PREFERRED EMBODIMENTS

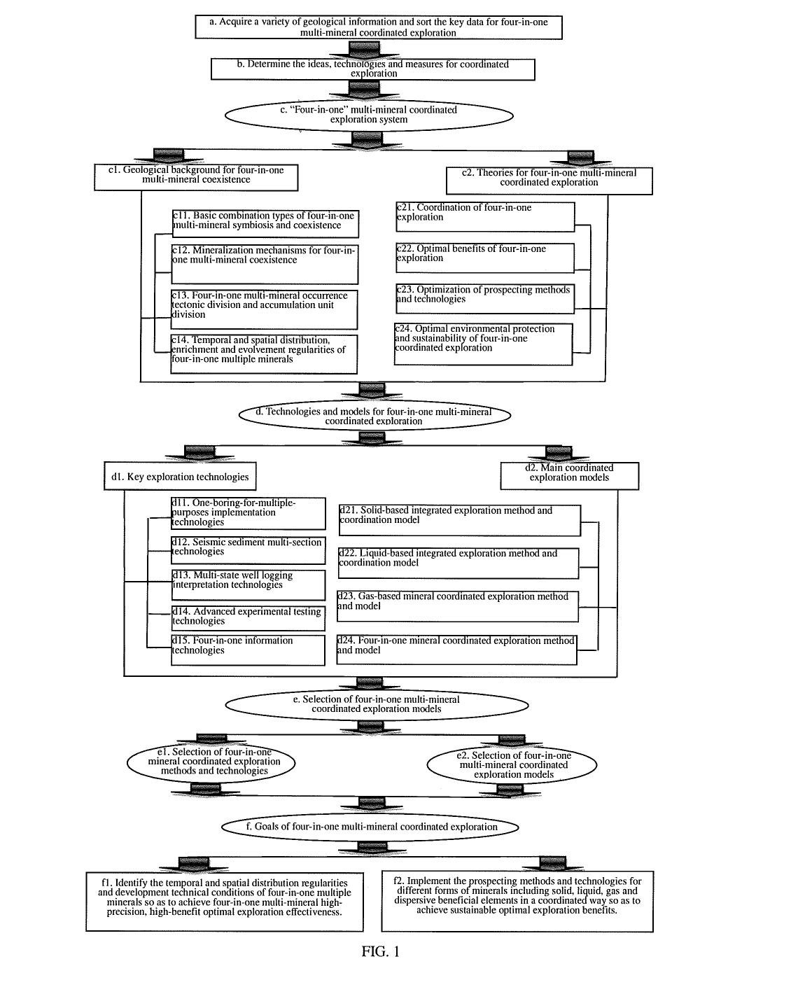

As illustrated in FIG. 1, a method of intergrowing and coexisting four-in-one mineral coordinated prospecting comprises the following steps:

a. Acquire a variety of geological information and sort the key data for four-in-one multi-mineral coordinated prospecting including acquisition and sorting of various mineral qualitative and quantitative data, words and figures and other basic data;

b. Determine the ideas, technologies and measures for coordinated prospecting: Conduct quantitative analysis for mineral types and their spatial distribution features and determine the main mineral types and prospecting ideas, the type of used technology and basic measures for coordination;

c. Four-in-one multi-mineral coordinated prospecting system: a four-in-one system that simultaneously considers the solid mineral, liquid mineral, gas mineral and element mineral as well as the confirmation of the coordinated prospecting technology;

d. Four-in-one multi-mineral coordinated prospecting technologies and models: Select advanced suitable prospecting methods and technologies and establish the solid-based, liquid-based, gas-based and four-in-one mineral coordinated prospecting methods and models on the principle of optimal benefit and sustainability;

e. Select four-in-one multi-mineral coordinated prospecting models: Select single minerals (solid-based, liquid-based or gas-based) or multi-mineral prospecting, their required methods and technologies and its matching coordinated prospecting models;

f. Goal to be achieved by four-in-one multi-mineral coordinated prospecting: To obtain optimal prospecting effectiveness with minimum input and the shortest construction period, thus realizing maximum benefit;

The steps above are the main-thread steps for four-in-one mineral coordination prospecting.

Among them, Step c includes determination of geological foundation for four-in-one multi-mineral coexistence and the theories for four-in-one multi-mineral coordinated prospecting;

Step c1: Geological foundation for four-in-one multi-mineral coexistence

The step is to provide the geological foundation for achieving the four-in-one multi-mineral coordinated prospecting system and the specific steps include:

c11. Basic combination types of four-in-one multi-mineral coexistence and gathering: The examples of solid minerals include coal, bauxite, clay mineral and oil shale, etc., the examples of liquid minerals include petroleum, the examples of gas minerals include coalbed methane, tight gas, shale gas, etc. and the examples of element minerals include lithium, gallium, germanium, uranium, etc.; the forms of multi-mineral coexistence and gathering include four-mineral coexistence, three-mineral gathering and two-mineral assembly;

c12. Mineralization mechanisms for four-in-one multi-mineral coexistence: Analyze the mineralization mechanisms for solid, liquid, gas and element multiple minerals and identify the main mineral controlling mechanisms so as to provide guidance for the prospecting practice;

c13. Four-in-one multi-mineral tectonic division and accumulation unit division: Determine the multi-mineral accumulation unit boundary, identify the controlling mechanism of mineral developing tectonics within each unit and define enrichment blocks;

c14. Temporal and spatial distribution, enrichment and evolvement regularities of four-in-one multiple minerals: Analyze the regularities of development and distribution, occurrence and enrichment of multiple minerals and their evolution in space from the view of time and space, thus providing theoretical guidance for multi-mineral coordinated prospecting.

Step c2: Theories for four-in-one multi-mineral coordinated prospecting

The step is to provide key theoretical guidance for achieving the four-in-one multi-mineral coordinated prospecting system and the specific steps include:

c21. Coordination of four-in-one prospecting: The coordinated prospecting is aimed at obtaining optimal prospecting results and achieving maximum economic benefits with minimum cost input, which requires systematic investigation into geological and geophysical conditions of the prospected blocks, selection of the most suitable prospecting technical means, prospecting construction organization forms and prospecting construction sequence and active implementation of the integrated coordinated trilateral work so as to maximize the benefits of prospecting works;

c22. Optimal benefits of four-in-one prospecting: Make careful economic benefit assessment for the selection of each prospecting technology, equipment input, program deployment and method adoption so as to select the coordinated prospecting program with optimal benefit;

c23. Optimization of prospecting methods and technologies: Evaluate the adaptability of various prospecting technologies and methods in specific prospected blocks on the basis of co-ordination of various prospecting technical means and methods and conduct optimization management so that all prospecting means, technologies and methods complement each other with advantages and the relationship in the implementation process of prospecting works is coordinated;

c24. Optimal environmental protection and sustainability of four-in-one coordinated prospecting: The coordinated prospecting program must include the evaluation report and technical parameters that are conducive to environmental protection and ensure the sustainability of resources prospecting, development and utilization.

In Step d, the said key prospecting technology d1 is to select the multi-energy mineral coordinated prospecting models and provide the specific technologies that are implemented in a coordinated way and the specific steps are:

d11. One-boring-for-multiple-purposes implementation technologies: Many borings for different purposes such as structural boring, parameter boring, prospecting boring and hydrographic boring are involved in the process of mineral prospecting; during the exploratory drilling engineering design, the positions, purposes and construction requirements of borings shall be considered fully and the purposes of borings shall be vigorously enhanced to minimize the number of borings so as to achieve one boring for multiple purposes which can greatly improve the efficiency of prospecting and save prospecting costs;

d12. Seismic sediment multi-section technologies: Mainly including the two-dimensional seismic and section technology, three-dimensional seismic and section technology, three-position three-component based high-precision geophysical prospecting technology, high-precision magnetic prospecting technology and other aspects that have made great progress, greatly enhancing the control level of the mineral underground occurrence states and providing effective guidance for the mineral prospecting and development;

d13. Multi-state well logging interpretation technologies: There are many types of well logging technologies which are of great significance, and especially in recent years, the well logging technologies have been developing rapidly in the fields of rock physical properties, well logging ground system, open-hole logging, casing log, well logging during drilling and so on. The advanced well logging technologies greatly improve the accuracy of the mineral prospecting;

d14. Advanced experimental testing technologies: Application of several types of advanced testing equipment and advanced testing technologies can timely identify intergrowing and coexisting and gathering multiple minerals, accurately analyze their grade, resources potential and other aspects and guide the estimation of resources; for example, advanced coal measure element detection technology, shale gas related testing technology, coalbed methane related testing technology and coalbed oil related testing technology can provide experimental support for one-prospecting-for-multiple-purposes efficient coordinated prospecting; and

d15. Four-in-one information technologies: including digitization and multi-dimensional informationization of stratum, mineral deposit and development conditions. In full conjunction with the production practice and working methods for multi-mineral resources prospecting and development and considering the features of specific geological survey spatial information, the software development platform that suits the requirements for multi-mineral resources prospecting and exploration functions has been developed and designed. At present, digital prospecting and digital mine works are being performed step by step, and the key technology of multi-mineral prospecting geological survey space information system is researched, which realizes the sharing of information among different departments.

Step d2: Main coordinated prospecting models

The step is to select the multi-energy mineral coordinated prospecting system and provide the methods and models that are implemented in a coordinated way and the specific steps are:

d21. Solid-based mineral integrated prospecting method and model: The examples of solid minerals include coal, bauxite, clay mineral and oil shale and the solid-based mineral prospecting is mainly aimed at identifying the developing environment, distribution and enrichment, tectonic control and occurrence regularities of solid minerals, thus establishing corresponding metallogenic models and prospecting models;

d22. Liquid-based integrated prospecting method and coordination model: The examples of liquid minerals include petroleum and the liquid-based mineral prospecting is mainly aimed at identifying the hydrocarbon generation potential of source rocks, reservoir performance, sealing conditions, migration pathway, accumulation conditions and preservation conditions, thus establishing corresponding metallogenic model and prospecting model;

d23. Gas-based mineral coordinated prospecting method and model: The examples of gas mineral include coalbed methane, tight gas, shale gas, etc., and like the liquid-based mineral prospecting, the gas-based mineral prospecting is mainly aimed at identifying the hydrocarbon generation potential of source rocks, reservoir performance, sealing conditions, migration pathway, accumulation conditions and preservation conditions, thus establishing corresponding metallogenic model and prospecting model; and

d24. Four-in-one mineral coordinated prospecting method and model: In addition to solid, liquid and gas minerals, there are element minerals such as lithium, gallium, germanium and uranium, such minerals are mostly enriched in solid minerals and have the almost same prospecting model as that of solid minerals. However, in some areas, there is not only one major mineral, but also minerals at a variety of occurrence states, which requires that the mineralization and enrichment features and prospecting features of various minerals are studied comprehensively in conjunction with the prospecting features of different-state minerals so that the integrated metallogenic model and prospecting model are established.

Step e comprises: e1 selection of four-in-one mineral coordinated prospecting methods and technologies, and e2 selection of four-in-one mineral coordinated prospecting models.

Step f is to achieve the following two goals of coordinated prospecting:

f1. Identify the temporal and spatial distribution regularities and development technical conditions of four-in-one multiple minerals so as to achieve four-in-one mineral high-precision, high-benefit optimal prospecting effectiveness;

f2. Implement the prospecting methods and technologies for different forms of minerals including solid, liquid, gas and dispersive beneficial elements in a coordinated way so as to achieve sustainable optimal prospecting benefits.

The steps above are the auxiliary-thread steps of the four-in-one mineral coordinated prospecting.

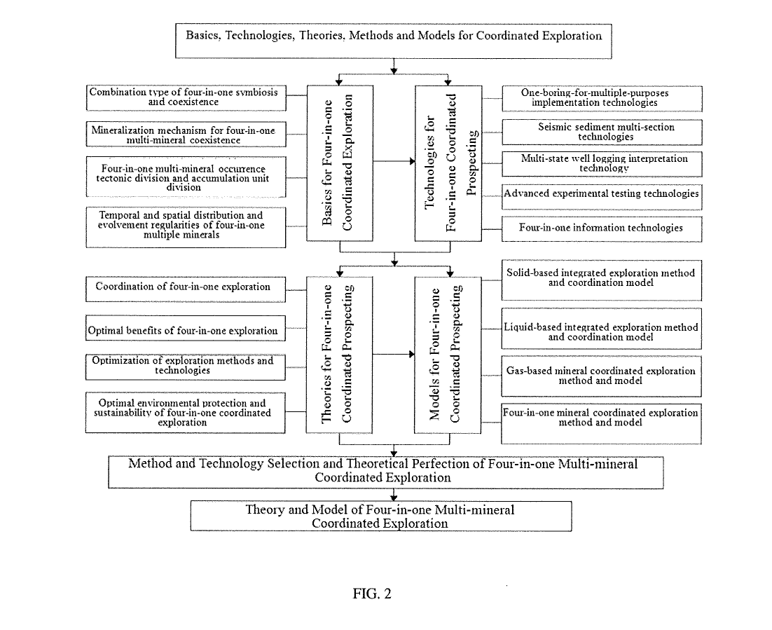

The present disclosure comprises two key parts: coordinated prospecting of multiple minerals and coordinated implementation of several prospecting technologies and methods. Multiple minerals include solid, liquid, gas and element (useful and harmful) four-in-one mineral series. Firstly, implement the coordinated prospecting to identify the occurrence states, occurrence regularities and developing conditions of multiple minerals so as to realize the coordinated prospecting and evaluation for these minerals and achieve high-precision high-benefit optimal prospecting effectiveness; secondly, implement different prospecting methods and technologies in a coordinated way and implement the exploratory drilling, geophysical prospecting, information technology and other technologies in a systematic and coordinated fashion so that the implementation of prospecting works achieves the optimal configuration, reduces unnecessary prospecting works, obtains sustainable optimal prospecting effectiveness with minimum input and enhances the technological level of multi-mineral integrated prospecting as a whole (FIG. 2).

The present disclosure gradually establishes the coordinated prospecting method that suits the geological features of the multi-mineral occurrence and has the characteristics of modern technologies based on the complicated geological conditions of multi-mineral co-existence by relying on the modern technologies for the purpose of standardizing the geological work of coordinated prospecting according to the requirements for the four-in-one minerals including solid, liquid, gas and element that can be identified. The method observes the following basic principles:

1) “From complicated to simple” principle

The prospecting method and evaluation method for different forms of underground minerals shall follow the basic principle that the minerals with high prospecting difficulty level are considered with priority and those minerals with low prospecting difficulty level should be attached to the former as possible. All possible efforts shall be made to settle the prospecting and evaluation of multiple minerals during the implementation of prospecting works.

2) Technology and method coordination principle

The advanced prospecting technology needs to be combined with the effective prospecting method and the actual geological conditions, construction method for mineral prospecting, performance and function of different prospecting technologies, prospecting construction sequence, prospecting work arrangement plan, key technical indexes and other aspects shall be considered in the process of prospecting. Implement the exploratory drilling, geophysical prospecting, remote sensing, geochemical exploration, information technology and other technologies and methods in a coordinated way so that the implementation of prospecting works achieves the optimal configuration, reduces unnecessary prospecting works, obtains sustainable optimal prospecting effectiveness with minimum input and enhances the technological level of multi-mineral integrated prospecting as a whole.

3) Main thread and auxiliary thread coordination principle

\textcircled{1} Make comprehensive study on the entire mining area and conduct entire study and overall layout for geological prospecting work for the mineral resources.

\textcircled{2} Persist in the principle of “taking the main mineral as main thread and the intergrowing and coexisting mineral as auxiliary thread, comprehensively evaluating several types of mineral occurrence and selecting optimal prospecting technologies and methods to implement coordinated prospecting”, make full use of and provide reasonable protection for mineral resources, carry out evaluation for multi-mineral prospecting, especially the prospecting for liquid, gas and beneficial element resources.

\textcircled{3} Use various technical means in a coordinated way so as to make them cooperate with each other and mutually verified so as to improve the geological prospecting effectiveness.

4) Gradual advancing principle

First of all, study the surface or shallow geological conditions, and then arrange the deep prospecting works according to the acquired geological information; carry out the layout and construction for the prospecting works from known to unknown and from sparse to dense. In the process of prospecting, carry out comprehensive study on multiple mineral deposits in such a way as to distinguish the priorities of the problems and solve these problems in proper order, not only highlighting the key points, but also considering the comprehensiveness of investigation and study.

The part not mentioned in the said embodiment can be achieved through taking or referencing the existing technologies.

It should be noted that the description above is only the implementation process of the present invention, and any modifications, equivalent replacements and improvements made within the spirit and principle of the present invention shall be included in the protection scope of the present invention.

1. A method of intergrowing and coexisting four-in-one mineral coordinated prospecting, wherein the method comprises:
a. acquiring geological information and sorting key data from the information for four-in-one multi-mineral coordinated prospecting;
b. conducting a quantitative analysis for mineral types and spatial distribution features of the mineral types and determining main mineral types and prospecting ideas, a type of used technology and basic measures for coordination;
c. determining a geological foundation for four-in-one multi-mineral co-existence and theories for four-in-one multi-mineral coordinated prospecting;
d. selecting advanced suitable prospecting methods and technologies and establishing solid-based, liquid-based, gas-based and four-in-one mineral coordinated prospecting models based on optimal benefit and sustainability; and
e. selecting corresponding four-in-one multi-mineral coordinated prospecting models for four-in-one mineral coordinated prospecting,
wherein the geological foundation for four-in-one multi-mineral coexistence in step c comprises:
c11. basic combination types of four-in-one multi-mineral coexistence and gathering: the forms of multi-mineral coexistence and gathering include four-mineral coexistence, three-mineral gathering and two-mineral assembly;
c12. analysis of mineralization mechanisms for solid, liquid, gas and element multiple minerals and identifying the main mineral controlling mechanism so as to provide guidance for prospecting practice;
c13. determining the multi-mineral accumulation unit boundary, identifying a controlling mechanism of mineral developing tectonics within each unit and define enrichment blocks;
c14. analyze regularities of development and distribution, occurrence and enrichment of multiple minerals and their evolution in space from the view of time and space, thus providing theoretical guidance for multi-mineral coordinated prospecting;
wherein the theories for four-in-one multi-mineral coordinated prospecting in step c comprise:
c21. coordinated prospecting aimed at obtaining optimal prospecting results and achieving maximum economic benefits with minimum cost input, which requires systematic investigation into geological and geophysical conditions of the prospected blocks, selection of the most suitable prospecting technical means, prospecting construction organization forms and prospecting construction sequence and active implementation of the integrated coordinated trilateral work so as to maximize the benefits of prospecting works;
c22. making careful economic benefit assessment for the selection of each prospecting technology, equipment input, program deployment and method adoption so as to select the coordinated prospecting program with optimal benefit;
c23. evaluating adaptability of various prospecting technologies and methods in specific prospected blocks on the basis of co-ordination of various prospecting technical means and methods and conduct optimization management so that all prospecting means, technologies and methods complement each other with advantages and the relationship in the implementation process of prospecting works is coordinated;
c24 including with the coordinated prospecting program the evaluation report and technical parameters that are conducive to environmental protection and ensure the sustainability of resources prospecting, development and utilization;
wherein the prospecting technologies in step d comprise:
d11 one-boring-for-multiple-purposes implementation technologies;
d12 seismic sediment multi-section technologies;
d13 multi-state well logging interpretation technologies;
d14 experimental testing technologies; and
d15 four-in-one information technologies; and
wherein the solid-based, liquid-based, gas-based and four-in-one mineral coordinated prospecting models in step d comprise:
d21. solid-based mineral coordinated prospecting model aimed at identifying the developing environment, distribution and enrichment, tectonic control and occurrence regularities of solid minerals, thus establishing corresponding metallogenic models and prospecting models;
d22. liquid-based mineral coordinated prospecting model aimed at identifying the hydrocarbon generation potential of source rocks, reservoir performance, sealing conditions, migration pathway, accumulation conditions and preservation conditions, thus establishing corresponding metallogenic model and prospecting model;
d23. gas-based mineral coordinated prospecting model aimed at identifying the hydrocarbon generation potential of source rocks, reservoir performance, sealing conditions, migration pathway, accumulation conditions and preservation conditions, thus establishing corresponding metallogenic model and prospecting model; and
d24. mineralization and enrichment features and prospecting features of various minerals are studied comprehensively in conjunction with the prospecting features of different-state minerals so that the integrated metallogenic model and prospecting model are established.

2-6. (canceled)
